(19) United States
(12) Patent Application Publication
(10) Pub. No.: US 2012/0240589 A1
(43) Pub. Date: Sep. 27, 2012

(54) POWER PLANT AND POWER PLANT OPERATING METHOD

(75) Inventors: Manabu TATEISHI, Yokohama-shi (JP); Takahiro MORI, Yokohama-shi (JP); Masayuki TOBO, Kawasaki-shi (JP); Kouichi KITAGUCHI, Yokohama-shi (JP)

(73) Assignee: KABUSHIKI KAISHA TOSHIBA

(21) Appl. No.: 13/425,837

(22) Filed: Mar. 21, 2012

(30) Foreign Application Priority Data
Mar. 22, 2011 (JP) 2011-063349

(51) Int. Cl. F01K 23/10; F01K 7/22; F01K 13/02; F02C 6/00

(52) U.S. Cl. 60/772; 60/39.182; 60/690; 60/679; 60/676; 60/660

(57) ABSTRACT

According to one embodiment, there is provided a power plant operating method. The method includes calculating by a turbine output calculating unit a turbine output based on an exponential value of a steam pressure measured at an arbitrary point downstream from the repeater, calculating by a power generator output calculating unit a power generator output generated by the power generator, detecting by an output deviation detecting unit a deviation between the turbine output and the power generator output, detecting by a power load unbalance detecting unit power load unbalance when the deviation exceeds a preset value, and outputting by a control unit a rapid close command to regulator valves of the steam turbine when the power load unbalance is detected.

### CROSS-REFERENCE TO RELATED APPLICATIONS

This application is based upon and claims the benefit of priority from prior Japanese Patent Application No. 2011-063349, filed Mar. 22, 2011, the entire contents of which are incorporated herein by reference.

### FIELD

Embodiments described herein relate generally to a power plant including a power load unbalance detecting function and a power plant operating method.

### BACKGROUND

FIG. 8 is a diagram showing a configuration of a combined cycle power plant which includes a conventional power load unbalance detecting circuit.

The combined cycle power plant shown in FIG. 8 is of a uniaxial type. The plant of this type includes a gas turbine (GT) 1, a gas turbine air compressor (COMP) 2, a steam turbine 3 and a power generator 4, which are directly connected on one axis. The plant also includes an exhaust heat recovery boiler (HRSG) 5, which recovers exhaust gas from the gas turbine 1 and generates steam.

The gas turbine air compressor (COMP) 2 takes in air purified by an intake air filter 6, obtains compressed air at high pressure and high temperature, and supplies it to a combustor 7. The combustor 7 is configured to combust fuel and introduce combustion gas to the gas turbine 1.

The steam turbine 3 includes a high-pressure turbine (HP) 3a, an intermediate-pressure turbine (IP) 3b and a low-pressure turbine (LP) 3c.

The exhaust heat recovery boiler 5 includes a casing of, for example, a horizontally long cylindrical shape. The casing contains a high-pressure second superheater 8, a repeater 9, a high-pressure first superheater 10, an intermediate-pressure superheater 11 and a low-pressure superheater 12, which are arranged in this order from an upstream side to a downstream side of the exhaust gas. Outside the casing, the exhaust heat recovery boiler 5 includes a high-pressure steam drum (HP) 13, an intermediate-pressure steam drum (IP) 14 and a low-pressure steam drum (LP) 15. Steam generated in the high-pressure steam drum 13 is sequentially superheated by the high-pressure first superheater 10 and the high-pressure second superheater 8. The superheated steam is introduced into and drives the high-pressure turbine 3a through a high-pressure main steam stop valve (not shown) and a high-pressure main steam regulator valve 17 provided in a high-pressure main steam pipe 16.

The steam that worked in the high-pressure turbine 3a is exhausted through a low-temperature reheat steam pipe 18. The exhausted steam joins together with an intermediate-pressure steam, which has been generated in the intermediate-pressure steam drum 14 and superheated by the intermediate-pressure superheater 11. The joined steam is guided to and heated by the reheater 9, and introduced into and drives the intermediate-pressure turbine 3b through a reheat steam regulator valve 20 provided in a high-temperature reheat steam pipe 19.

Low-pressure steam generated by the low-pressure steam drum 15 and then superheated by the low-pressure superheater 12 is introduced into an intermediate stage or an exhaust side of the intermediate-pressure turbine 3b through a low-pressure main steam regulator valve 22 in a low-pressure main steam pipe 21. The introduced steam joins together with the steam that worked in the intermediate-pressure turbine 3b. The joined steam is introduced into and drives the low-pressure turbine 3c.

A steam condenser 23 condenses the steam that worked in the low-pressure turbine 3c. A condensing pump 24 supplies the condensate water to the low-pressure steam drum 15 of the exhaust heat recovery boiler 5.

In FIG. 8, a reference numeral 29 denotes a steam pressure detector (pressure sensor) provided in the low-temperature reheat steam pipe 18. A reference numeral 33 denotes a current transformer (CT) provided in an output circuit of the power generator 4 to detect a power generator current. A reference numeral 60 denotes an exhaust gas temperature detector (temperature sensor) which measures a temperature T of the exhaust gas of the gas turbine 1. A reference numeral 61 denotes a fuel flow rate detector (flow rate sensor) which measures a flow rate G of the fuel supplied to the gas turbine combustor 7.

In the conventional combined cycle power plant as described above, if trouble occurs in a power system which supplies power from the power generator 4, a protection relay system (not shown) of the power system shuts down a relay to release the power generator 4 from the power system to protect the devices. Then, from this moment, the uniaxial turbine including the gas turbine 1 and the steam turbine 3 is brought to an overpower state and overspeeds. However, upon detection of the release of the relay (occurrence of load rejection), the high-pressure main steam regulator valve 17, the reheat steam regulator valve 20 and the low-pressure main steam regulator valve 22, which control the number of revolutions of the steam turbine, are immediately closed, so that the overspeed of the steam turbine 3 is suppressed.

If trouble occurs in a power supply system at a longer distance, it is difficult to detect the release of the relay (far load rejection) of the system in the trouble at the power plant including the combined cycle power plant because of the long distance. To solve this problem, the plant is provided with a power load unbalance detecting circuit 25 which detects power load unbalance based on deviation between a turbine output (power) 45 and a power generator output (load) 35.

The conventional power load unbalance detecting circuit 25 will be specifically described below with reference to FIG. 9.

The turbine output (power) 45 is obtained as follows. First, to calculate a steam turbine output, a high-pressure turbine exhaust steam pressure signal 30 from the steam pressure detector 29 as a pressure representative measuring point in the low-temperature reheat steam pipe 18, through which the exhaust steam from the high-pressure turbine 3a is introduced into a steam turbine output calculation unit 40 that obtains a steam turbine output 41 by calculation. Then, the temperature T of the exhaust gas of the gas turbine 1 measured by the exhaust gas temperature detector 60 or the flow rate G of the fuel supplied to the gas turbine combustor 7 detected by the fuel flow rate detector 61 is introduced into a gas turbine output calculation unit 42, which obtains a gas turbine output 43 by calculation. These outputs are added by an adder 44, with the result that a turbine output (power) 45 is obtained.

On the other hand, a current 33a measured by the current transformer 33 provided at a terminal of the power generator 4 is introduced into a power generator output calculation unit 34, which obtains the power generator output (load) 35 by calculation.

A subtracter 46 subtracts the power generator output (load) 35 from the turbine output (power) 45, and inputs a deviation δ to an under-preset-value detection comparator 47. The under-preset-value detection comparator 47 compares the input deviation δ with a preset value (e.g., 40%). If the input deviation δ exceeds the preset value, the under-preset-value detection comparator 47 outputs a signal of the logical value “1” to one of input terminals of an AND circuit 49.

A power generator output change rate calculation unit 36 receives the power generator output 35, obtains a power generator output change rate 37 and inputs it to an under-preset-value detection comparator 38. The under-preset-value detection comparator 38 compares the power generator output change rate 37 with a preset value (e.g., −40%/20 msc). If the power generator output change rate 37 is equal to or lower than the preset value (that is, if the absolute value of the power generator output change rate 37 is equal to or greater than the absolute value of the preset value), the under-preset-value detection comparator 38 outputs an output signal 39 of the logical value “1” to the other of the input terminals of the AND circuit 49.

When both the condition that the deviation δ between the turbine output 45 and the power generator output 35 exceeds 40% and the condition that the power generator output change rate 37 is equal to or lower than −40%/20 msc are satisfied, the AND circuit 49 detects occurrence of power load unbalance, and inputs an output signal of the logical value “1” to a set terminal S of a hold circuit 50 including an SR flip-flop circuit. Once the hold circuit 50 receives the output signal from the AND circuit 49 input to the set terminal S, it continuously outputs an output signal 51, until the deviation δ between the turbine output 45 and the power generator output 35 is reduced to less than the detection level at the under-preset-value detection comparator 47 and accordingly a NOT circuit 48 inputs an inversion signal of the under-preset-value detection comparator 47 to a reset terminal R. The output signal is input to a high-pressure main steam regulator valve controller 52, a reheat steam regulator valve controller 53 and a low-pressure main steam regulator valve controller 54, which respectively output a high-pressure main steam regulator valve operating command 26, a reheat steam regulator valve operating command 27 and a low-pressure main steam regulator valve operating command 28.

As described above, the conventional combined cycle power plant uses the high-pressure turbine exhaust steam pressure signal 30 measured by the steam pressure detector 29, as a pressure representative measuring point to calculate the steam turbine output 41, provided in the low-temperature reheat steam pipe 18 on the exhaust side of the high-pressure turbine 3a

Actually, however, the steam that worked in the high-pressure turbine 3a is superheated by the reheater 9 after it joins the steam generated in the intermediate-pressure drum 14, introduced into the intermediate-pressure turbine 3b and works there. Further, the steam that worked in the intermediate-pressure turbine 3b joins the steam generated in the low-pressure drum 15 at the intermediate stage or the exhaust side of the intermediate-pressure turbine 3b and works in the low-pressure turbine 3c.

Thus, the steam turbine output 41 calculated from the high-pressure turbine exhaust steam pressure signal 30 measured by the steam pressure detector 29 on the exhaust side of the high-pressure turbine 3a does not reflect an actual output, since an output produced by the steam generated in the intermediate-pressure drum 14 and the low-pressure drum 15 is not taken into account. Therefore, the power load unbalance detecting circuit 25 does not accurately detect power load unbalance.

### BRIEF DESCRIPTION OF THE DRAWINGS

FIG. 1 is a diagram showing an example of a configuration of a combined cycle power plant which includes a power load unbalance detecting circuit according to a first embodiment;

FIG. 2 is a diagram showing an example of a configuration of the power load unbalance detecting circuit of the first embodiment;

FIG. 3 is a graph showing a change rate of a steam turbine output and a change rate of a steam pressure downstream of a reheat steam regulator valve when a temperature of a high-temperature reheat steam changes;

FIG. 4 is a graph showing a change rate of a steam turbine output and a change rate of an exponential value of a steam pressure downstream of the reheat steam regulator valve when a temperature of a high-temperature reheat steam changes;

FIG. 5 is a diagram showing an example of a configuration of a combined cycle power plant which includes a power load unbalance detecting circuit according to a second embodiment;

FIG. 6 is a diagram showing an example of a configuration of a combined cycle power plant which includes a power load unbalance detecting circuit according to a third embodiment;

FIG. 7 is a diagram showing an example of a configuration of the power load unbalance detecting circuit of the third embodiment;

FIG. 8 is a diagram showing a configuration of a combined cycle power plant which includes a conventional power load unbalance detecting circuit; and

FIG. 9 is a diagram showing an example of a configuration of the conventional power load unbalance detecting circuit.

### DETAILED DESCRIPTION

Embodiments will be described below with reference to the drawings. In general, according to one embodiment, there is provided a combined cycle power plant. The combined cycle power plant comprises: a steam turbine including a high-pressure turbine, an intermediate-pressure turbine and a low-pressure turbine; a gas turbine disposed coaxially with the steam turbine; a power generator disposed coaxially with the steam turbine and the gas turbine; and an exhaust heat recovery boiler, which recovers exhaust gas from the gas turbine, generates steam and includes a high-pressure drum, an intermediate-pressure drum, a low-pressure drum and a reheater. The combined cycle power plant is configured to introduce steam generated in the high-pressure drum into the high-pressure turbine through a high-pressure main steam regulator valve and drive the high-pressure turbine, join exhaust steam of the high-pressure turbine with steam generated in the intermediate pressure drum, supply and reheat the joined exhaust steam in the reheater, guide the steam reheated by the reheater to the intermediate-pressure turbine through a reheat steam regulator valve to drive the intermediate-pressure turbine, and guide steam generated in the low-pressure drum and passed through a low-pressure steam regulator valve together with steam that has been guided to and worked in the intermediate-pressure turbine to the low-pressure turbine and drive the low-pressure turbine. The combined cycle power plant further comprises: a gas turbine output calculating unit configured to calculate a gas turbine output; a steam turbine output calculating unit configured to calculate a steam turbine output; a turbine output calculating unit configured to add the gas turbine output and the steam turbine output together and calculate a turbine output; a power generator output calculating unit configured to calculate a power generator output generated by the power generator; an output deviation detecting unit configured to detect a deviation between the turbine output and the power generator output; a power load unbalance detecting unit configured to detect power load unbalance when the deviation detected by the output deviation detecting unit exceeds a preset value; and a control unit configured to output a rapid close command to regulator valves of the steam turbine based on a power load unbalance signal output from the power load unbalance detecting unit. The steam turbine output calculating unit is configured to calculate the steam turbine output based on an exponential value of a steam pressure measured at an arbitrary point downstream from the reheater.

### First Embodiment

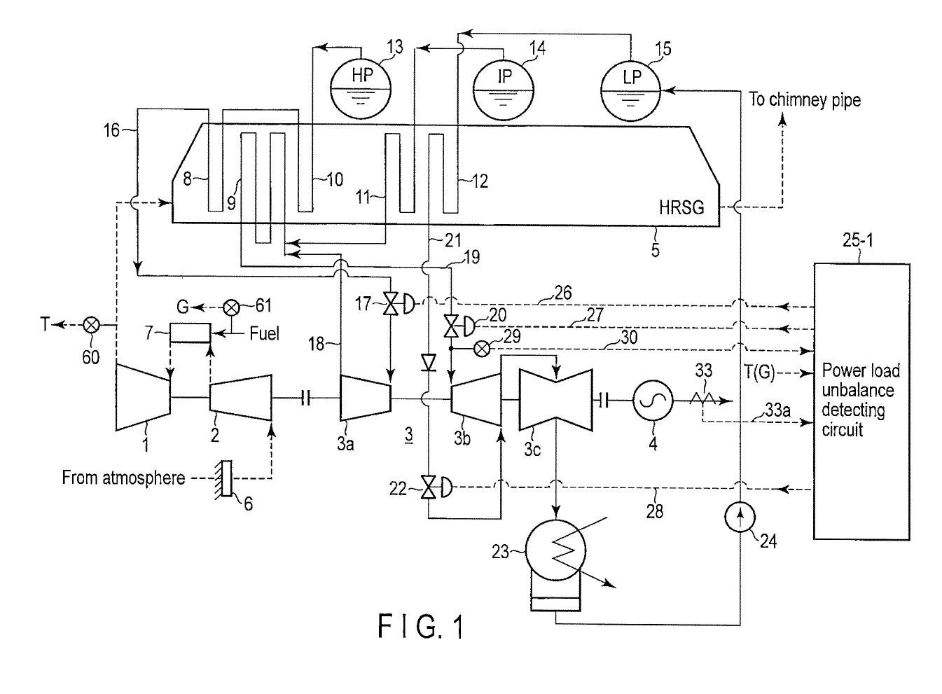

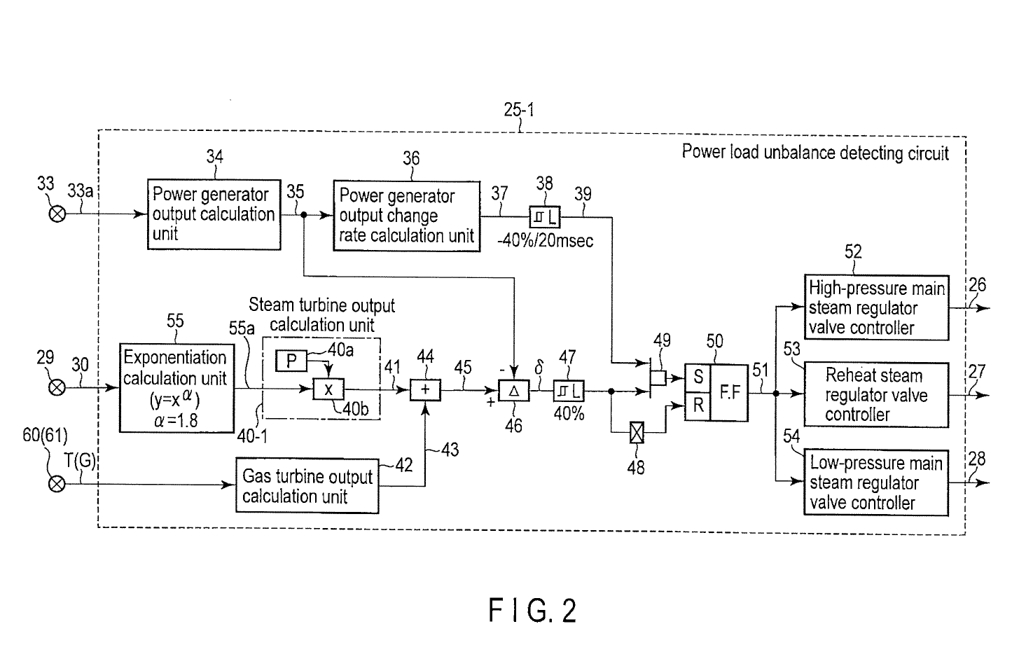

FIG. 1 is a diagram showing an example of a configuration of a combined cycle power plant which includes a power load unbalance detecting circuit according to a first embodiment, and FIG. 2 is a diagram showing an example of a configuration of the power load unbalance detecting circuit of the first embodiment.

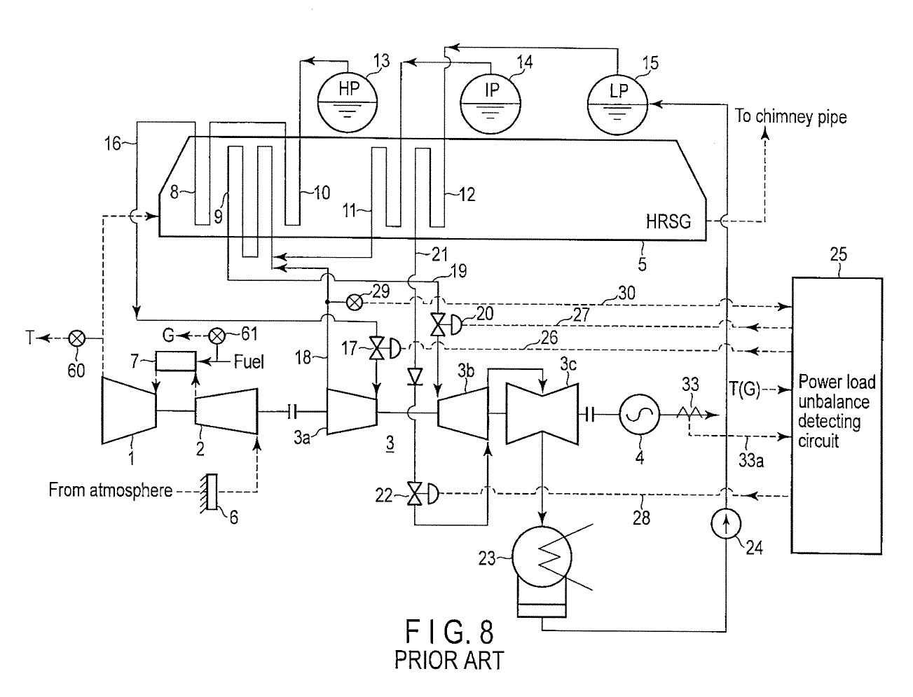

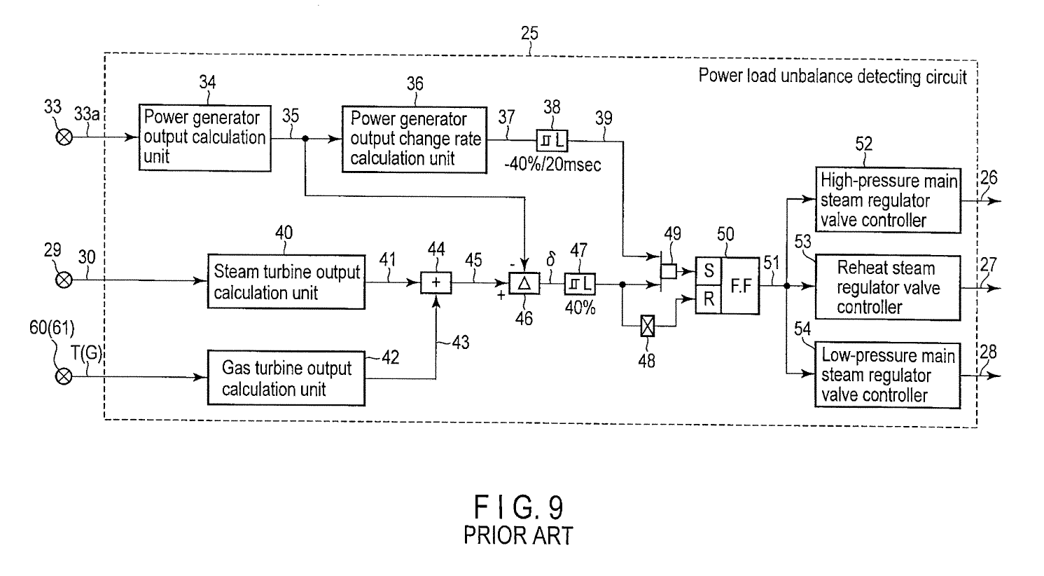

In the description below, the elements that are shown in FIG. 1 and are the same as those described with reference to FIGS. 8 and 9 are identified by the same reference symbols as those used in FIGS. 8 and 9.

Referring to FIG. 1, a combined cycle power plant of the first embodiment, as well as the system configuration shown in FIG. 8, includes a gas turbine 1, a compressor 2, a steam turbine 3 and a power generator 4, which are directly connected on the same axis and thus constitutes a uniaxial type combined plant. Exhaust gas from the gas turbine 1 is introduced into an exhaust heat recovery boiler 5, and sequentially exchanges heat with water and steam passing through a high-pressure second superheater 8, a reheater 9, a high-pressure first superheater 10, an intermediate-pressure superheater 11, a low-pressure superheater 12, high, intermediate or low-pressure evaporators (not shown), etc. Then, the exhaust gas is dispersed in the air through a chimney pipe.

Steam generated in the high-pressure drum 13 is superheated by the high-pressure first superheater 10 and the high-pressure second superheater 8. The superheated steam is introduced into and drives a high-pressure turbine 3a through a high-pressure main steam stop valve (not shown) and a high-pressure main steam regulator valve 17 provided in a high-pressure main steam pipe 16. The high-pressure steam that worked in the high-pressure turbine 3a is exhausted through a low-temperature reheat steam pipe 18, joins together with steam from the intermediate-pressure superheater 11, and is introduced into the reheater 9. The high-temperature reheated steam reheated by the reheater 9 passes through a high-temperature reheat steam pipe 19 and is introduced into an intermediate-pressure turbine 3b through a reheat steam regulator valve 20. The steam that worked in the intermediate-pressure turbine 3b joins together with low-pressure steam generated by a low-pressure drum 15 and guided through the low-pressure superheater 12, a low-pressure main steam pipe 21 and a low-pressure main steam regulator valve 22 at an intermediate stage or an exhaust side of the intermediate-pressure turbine 3b. The joined steam is introduced into and drives a low-pressure turbine 3c.

Thus, driving force of the gas turbine 1 and the steam turbine 3, which includes the high-pressure turbine 3a, the intermediate-pressure turbine 3b and the low-pressure turbine 3c, drives the power generator 4 to generator electric power.

The first embodiment differs from the conventional art, for example, in the following respects: the pressure representative measuring point to calculate a steam turbine output 41 is provided not in the low-temperature reheat steam pipe 18 on the exhaust side of the high-pressure turbine 3a but in an arbitrary point downstream from the reheater 9 (in the example shown in FIG. 1, a steam pressure detector 29 which measures a steam pressure is provided in an arbitrary point in a high-temperature steam reheat pipe 19 downstream from the reheat steam regulator valve 20); and a power load unbalance detecting circuit 25-1, which receives and processes a signal indicative of measured steam, has a circuit configuration different in part from that of the conventional power load unbalance detecting circuit (the example shown in FIG. 2 additionally includes an exponentiation calculation unit 55, which exponentiates the value of the measured steam pressure).

The power load unbalance detecting circuit 25-1 will be specifically described below with reference to FIG. 2.

In the power load unbalance detecting circuit 25-1 shown in FIG. 2, a current 33a measured by a current transformer 33 is introduced into a power generator output calculation unit 34, which obtains a power generator output (load) 35 by a predetermined arithmetic expression. The obtained power generator output (load) 35 is input to a subtracter 46 to be described later, and introduced into a power generator output change rate calculation unit 36 to obtain a power generator output change rate 37. The obtained power generator output change rate 37 is input to an under-preset-value detection comparator 38 and compared with a preset value (e.g., −40%/20 msc). If the power generator output change rate 37 is equal to or lower than the preset value (that is, if the absolute value of the power generator output change rate 37 is equal to or greater than the absolute value of the preset value), the under-preset-value detection comparator 38 outputs an output signal 39 of the logical value “1” to one of input terminals of an AND circuit 49.

A high-temperature reheat steam pressure signal 30 measured by the steam pressure detector 29 is introduced into the exponentiation calculation unit 55. The value of the high-temperature reheat steam pressure signal 30 is exponentiated by an exponential coefficient α preset in the exponentiation calculation unit 55. As a result, the value of an exponentiated pressure signal 55a is obtained. Assuming that the value of the high-temperature reheat steam pressure signal 30 is x and the value of the exponentiated pressure signal 55a is y, the relationship between the values is expressed by the equation y=xα. The value of the exponentiated pressure signal 55a (that is, the value obtained by exponentiating the value of the high-temperature reheat steam pressure signal 30 by the exponential coefficient α) is accurately proportional to an actual output of the steam turbine, even when the high-temperature reheat steam temperature varies.

The exponential coefficient α is set to an optimum value based on the heat balance of the combined cycle power plant actually applied, such that the rate of a change of the exponentiated pressure signal 55a (that is, the value obtained by exponentiating the value of the high-temperature reheat steam pressure signal 30 by the exponential coefficient α) can be most accurately proportional to the rate of a change of the value of the steam turbine output. The optimum value of exponential coefficient α varies depending on a pressure detecting position.

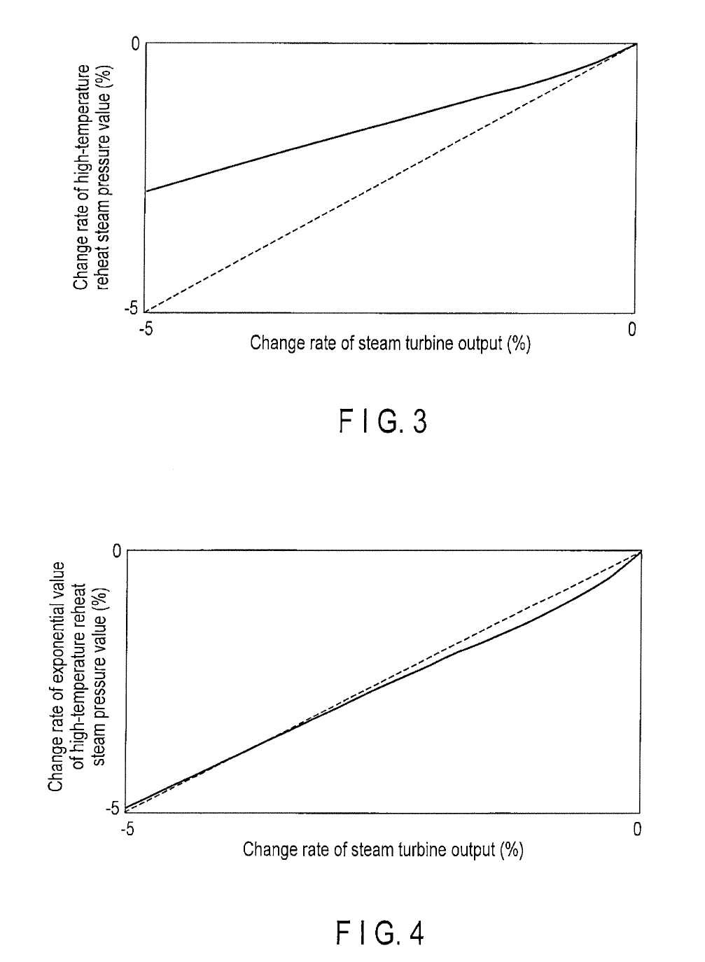

The optimum value of the exponential coefficient α can be obtained by, for example, simulation performed by a computer. For example, the relationship between “a rate of change of a steam turbine output” and “a rate of change of an exponential value of a high-temperature reheat steam pressure” when a temperature of the high-temperature reheat steam changes is expressed by a function of a graph based on the heat balance. For example, the exponential coefficient α is changed to change the function to find a position where the rates of change of the two values are most accurately proportional. The value of the exponential coefficient α at that position is selected. The graph of FIG. 3 shows an example in which if the exponential coefficient α is “0” (that is, if an exponential operation is not carried out), the relationship between the rates of change of the two values (represented by a solid line) is far from the ideal proportional relationship (represented by a broken line). On the other hand, the graph of FIG. 4 shows an example in which if the exponential coefficient α is “1.8”, the relationship between the rates of change of the two values (represented by a solid line) substantially coincides with the ideal proportional relationship (represented by a broken line). In this embodiment, “1.8” is selected as the optimum value of the exponential coefficient α and set in the exponentiation calculation unit 55.

The exponentiated pressure signal 55a output from the exponentiation calculation unit 55 is introduced into a steam turbine output calculation unit 40-1. A gain P which determines a proportion (inclination) of the proportional relation is preset in a setting unit 40a of the steam turbine output calculation unit 40-1. The gain P and the value of the exponentiated pressure signal 55a are multiplied by a multiplier 40b, and thus a value of the steam turbine output 41 is obtained. Specifically, assuming that the value of the exponentiated pressure signal 55a is y and the value of the steam turbine output 41 is y′, y′ is calculated by the equation y′=P·y. The value of the steam turbine output 41 thus calculated substantially coincides with the value of an actual output of the steam turbine.

Although FIG. 2 shows an example in which the exponentiation calculation unit 55 is provided outside the steam turbine output calculation unit 40-1, the exponentiation calculation unit 55 may be provided inside the steam turbine output calculation unit 40-1.

The configurations and functions of the power load unbalance detecting circuit 25-1, other than those described above, are the same as in the conventional art. Therefore, duplication of explanations is omitted.

According to the first embodiment, the value of the high-temperature reheat steam pressure signal 30 is exponentiated by the exponential coefficient α to calculate the value of an exponentiated pressure signal 55a, and the value of the steam turbine output 41 is calculated from the value of an exponentiated pressure signal 55a. Therefore, even if the high-temperature reheat steam temperature increases or decreases, the value of the steam turbine output 41 can be calculated with satisfactory accuracy. Therefore, if far load rejection occurs, the power load unbalance can be detected with high accuracy. Accordingly, the high-pressure main steam regulator valve 17, the reheat steam regulator valve 20 and the low-pressure main steam regulator valve 22, which control the number of revolutions of the steam turbine, are immediately closed, so that the overspeed of the uniaxial turbine including the gas turbine 1 and the steam turbine 3 due to the far load rejection can be suppressed. At the same time, the output of the gas turbine 1 can be immediately decreased to a minimum level that allows flame holding, so that the overspeed can be suppressed.

Further, according to the first embodiment, since the steam turbine output calculation unit 40-1 produces the desired steam turbine output 41 only with simple multiplying means as well as the conventional art, it need not additionally include any element which carries out a complicated arithmetic operation or setting operation (e.g., a function generator).

In the example shown in FIG. 1, the high-temperature reheat steam pressure is used as the steam pressure to detect power load unbalance, and the high-temperature reheat steam pressure signal 30 is obtained by the steam pressure detector 29 disposed downstream from the reheat steam regulator valve 20 as the representative measuring point to measure the high-temperature reheat steam pressure. This is because, from a practical viewpoint, such as a method of actually disposing the pressure detector and maintenance or inspection of the pressure detector, the steam pressure detector 29 can be easily handled if it is disposed in the lead pipe extending from the reheat steam regulator valve 20 to the high-pressure steam turbine 3a. However, the steam pressure detector 29 may be disposed in any position downstream from the reheater 9, because the steam pressure which gives the proportional relation between the exponentiated pressure signal 55a and the actual output of the steam turbine can be obtained at any position downstream from the reheater 9 including the high-temperature reheat steam pipe 19 as well as downstream from the reheat steam regulator valve 20. For example, the values of the steam turbine output 41 and the exponentiated pressure signal 55a are proportional even at the pressure in a middle stage of the intermediate-pressure turbine 3b (for example, in a third embodiment described later, the pressure detecting position is provided in a middle stage of the intermediate-pressure turbine 3b). If the pressure detecting position is provided further downstream from the middle stage of the intermediate-pressure turbine 3b, it is more difficult to obtain an accurate proportional relation between the values of the steam turbine output 41 and the exponentiated pressure signal 55a. However, the accuracy of detecting power load unbalance can be increased as compared to the conventional art.

### Second Embodiment

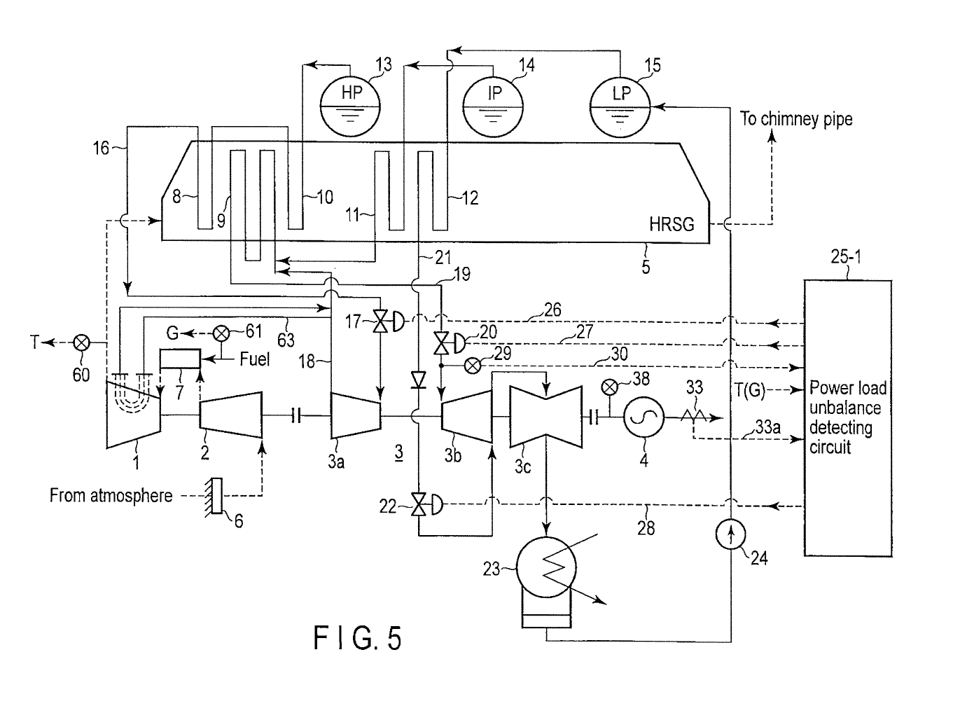

FIG. 5 is a diagram showing an example of a configuration of a combined cycle power plant which includes a power load unbalance detecting circuit according to a second embodiment. The power load unbalance detecting circuit of the second embodiment is the same in configuration as the power load unbalance detecting circuit 25-1 of the first embodiment shown in FIG. 2. Therefore, illustrations and explanations thereof are omitted.

In the combined cycle power plant of the second embodiment, in order to increase the efficiency, a cooling steam system to cool a high-temperature portion of a gas turbine branches off from a low-temperature reheat steam system, through which the exhaust steam from a high-pressure turbine 3a flows. Specifically, as shown in FIG. 5, a cooling steam system 63 branched off from a low-temperature reheat steam pipe 18 on an exhaust side of the high-pressure turbine 3a is configured to cool a high-temperature portion (for example, rotor vanes or stator vanes) of the gas turbine. Thus, a steam cooled gas turbine is formed.

In this configuration, a large amount of steam that cooled the high temperature portion of the gas turbine and heated to an extremely high temperature flows in the low-temperature reheat pipe 18 again. Thus, the high-temperature reheat steam temperature changes more drastically as compared to the combined cycle power plant of the first embodiment. Therefore, power load unbalance cannot be detected accurately by the conventional power load unbalance detecting method. In the second embodiment, since a steam pressure detector 29 is disposed downstream from a gas turbine cooling unit (not shown) in the cooling steam system 63, the steam turbine output 41 and the exponentiated pressure signal 55a can be proportional by the exponential operation described above or the like, and power load unbalance can be detected accurately.

### Third Embodiment

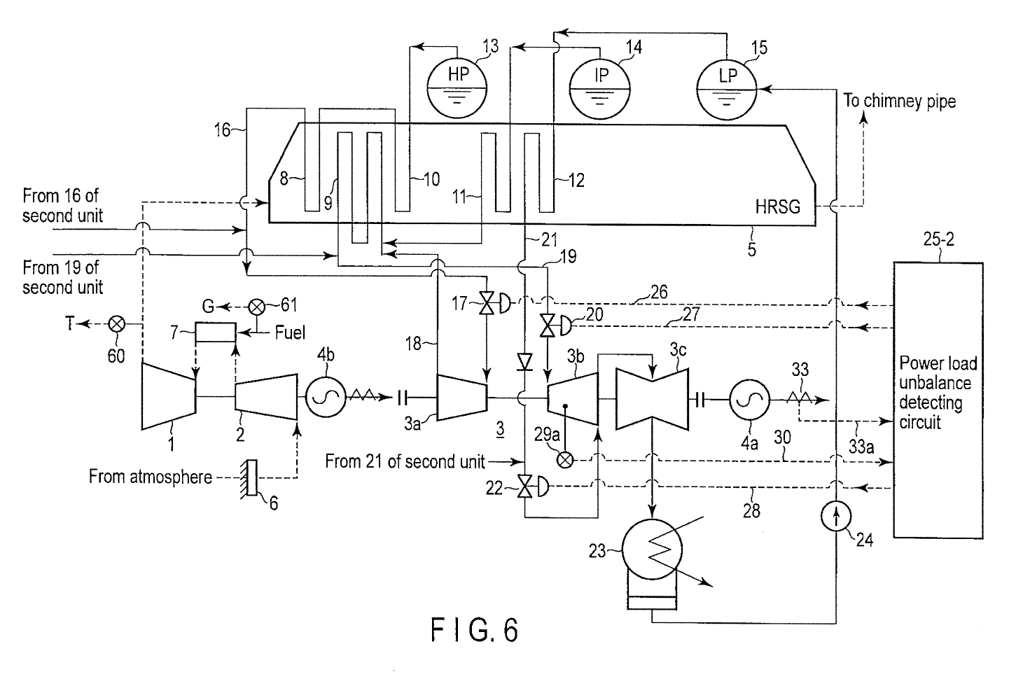

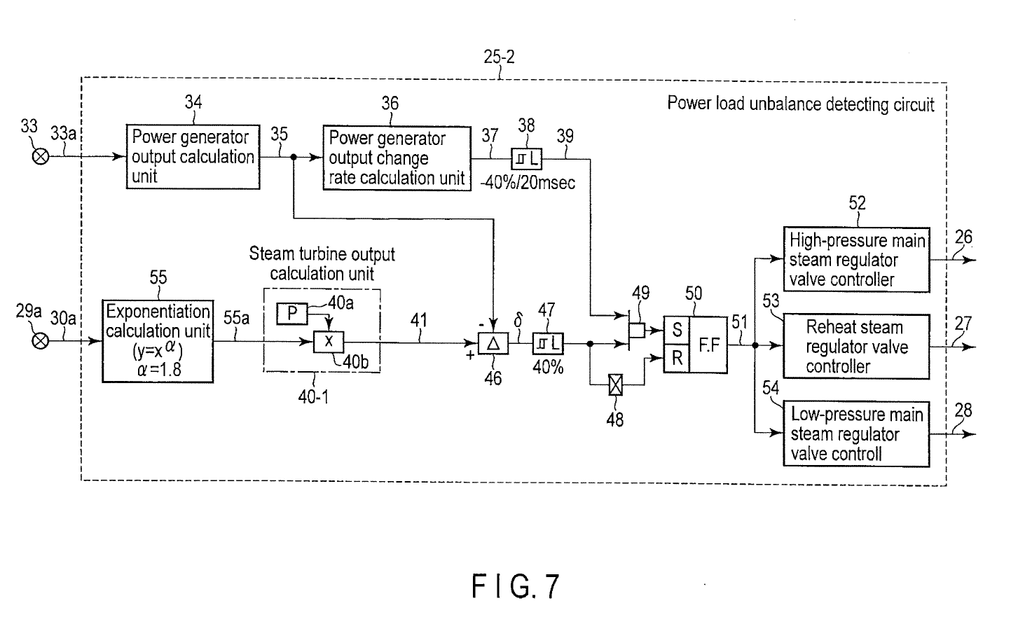

FIG. 6 is a diagram showing an example of a configuration of a combined cycle power plant which includes a power load unbalance detecting circuit according to a third embodiment, and FIG. 7 is a diagram showing an example of a configuration of the power load unbalance detecting circuit of the third embodiment. The same parts as those of the first embodiment shown in FIGS. 1 and 2 are identified by the same reference symbols as those used in FIGS. 1 and 2, and explanations thereof are omitted.

The third embodiment is a multi-axial type combined cycle power plant, not a uniaxial type combined cycle power plant of the first and second embodiments, in which the gas turbine 1, the steam turbine 3 and the power generator 4 are arranged on one axis.

In the multi-axial type combined cycle power plant as shown in FIG. 6, a steam turbine 3 including a high-pressure steam turbine 3a, an intermediate-pressure steam turbine 3b and a low-pressure steam turbine 3c is disposed on one axis, while a gas turbine 1 and an air compressor 2 are disposed on another axis. A power generator 4a is disposed on the axis of the steam turbine 3 and a power generator 4b is disposed on the axis of the gas turbine 1.

In the third embodiment, the gas turbine 1, the air compressor 2, the power generator 4b and an exhaust heat recovery boiler 5 constitute a first unit. The third embodiment further includes a second unit (not shown) having the same configurations as the first unit. A high-pressure main steam pipe 16, a high-temperature reheat steam pipe 19 and a low-pressure main steam pipe 21 of the heat recovery boiler 5 of the second unit are respectively connected to a high-pressure main steam pipe 16, a high-temperature reheat steam pipe 19 and a low-pressure main steam pipe 21 of the heat recovery boiler 5 of the first unit. Therefore, the high-pressure main steam, the high-temperature reheat steam and the low-pressure main steam of both units are joined together and supplied to the steam turbine 3. Although the multi-axial type combined cycle power plant of this embodiment includes two units, it may be configured to include three or more units.

Specifically, in the multi-axial type combined cycle power plant, steam generated in the high-pressure drums 13 of all units is joined together. The joined steam is introduced into and drives the high-pressure turbine 3a through a high-pressure main steam regulator valve 17. Exhaust steam from the high-pressure turbine 3a is joined together with steam generated in an intermediate-pressure drum 14 and supplied to a reheater 9 and heated therein. Steam reheated by the reheaters 9 of all units is joined together, and guided to the intermediate-pressure turbine 3b through the reheat steam regulator valve 20 and drives the intermediate-pressure turbine 3b. Steam generated in low-pressure drums 15 of all units is joined together and guided to and drives a low-pressure turbine along with steam passed through a low-pressure main steam regulator valve 22 and steam that worked in the intermediate-pressure turbine.

In the third embodiment, a steam pressure is measured in an arbitrary position downstream from the position where the high-temperature reheat steam pipe 19 of the first unit and the high-temperature reheat steam pipe 19a of the second unit are connected, that is, downstream from the position where the steam exhausted from the reheater 9 of the first unit and the steam exhausted from the reheater 9a of the second unit are joined together. A steam turbine output is calculated on the basis of an exponential value of the measured steam pressure. FIG. 6 shows an example in which a steam pressure detector 29a to measure the stream pressure is disposed in a middle stage of the intermediate-pressure turbine 3b.

The third embodiment differs from the first and second embodiments also in that a power generator current input to a power load unbalance detecting circuit 25-2 is only a power generator current 33a from the power generator 4a, and a power generator current from the power generator 4b is not input to the power load unbalance detecting circuit 25-2. This is because the power load unbalance detecting circuit 25-2 only detects power load unbalance between an output of the steam turbine 3 and an output of the power generator 4a, and because only the power generator 4a is driven by the steam turbine 3 and the power generator 4b is irrelevant. Power load unbalance between an output of the gas turbine 1 and an output of the power generator 4b is detected by another power load unbalance detecting circuit not shown in FIG. 6.

The third embodiment differs from the first and second embodiments also in that, as shown in FIG. 7, the power load unbalance detecting circuit 25-2 does not include a gas turbine output calculation unit 42 for the same reason as described above. Power load unbalance is detected on the basis of a deviation δ between a steam turbine output (power) 41 and a power generator output (load) 35 calculated by a steam turbine output calculation unit 40-1. The other parts are the same as those of the power load unbalance detecting circuit 25-2 shown in FIG. 2.

According to the third embodiment, in the case of the multi-axial type combined cycle power plant, as well as the uniaxial type l type combined cycle power plant, a value of the steam turbine output 41 is calculated from the value of an exponentiated pressure signal 55a, which is obtained by exponentiating a value of a high-temperature reheat steam pressure signal 30 by an exponential coefficient α. Therefore, even if the high-temperature reheat steam temperature increases or decreases, the value of the steam turbine output 41 can be calculated with satisfactory accuracy. Furthermore, power load unbalance is detected on the basis of a deviation δ between the steam turbine output 41 and the power generator output 35. Therefore, if far load rejection occurs, the power load unbalance can be detected with high accuracy.

### Others

In the first to third embodiments described above, the combined cycle power plant includes, for example, the gas turbine and the exhaust heat recovery boiler. However, it is clear that the invention is applicable to a general power plant including a normal boiler.

For example, the invention is applicable to a thermal power plant comprising: a steam turbine which includes a high-pressure turbine, an intermediate-pressure turbine and a low-pressure turbine; a power generator disposed coaxially with the steam turbine; a boiler having a superheater which generates main steam for the high-pressure turbine and a reheater which heats steam exhausted from the high-pressure turbine, the main steam generated from the superheater being introduced into the high-pressure turbine through a main steam regulator valve to drive the high-pressure turbine, the steam exhausted from the high-pressure turbine being supplied to the reheater to be heated, the steam reheated by the reheater being guided to the intermediate-pressure turbine through a reheat steam regulator valve to drive the intermediate-pressure turbine, steam exhausted from the intermediate-pressure turbine being guided to the low-pressure turbine to drive the low-pressure turbine.

In this case, a power load unbalance detecting circuit of the power plant is configured to calculate a turbine output of a steam turbine based on an exponential value of a steam pressure measured at an arbitrary point downstream from the reheater, obtain a power generator output generated from the power generator, detect a deviation between the turbine output and the power generator output, detect power load unbalance if the deviation exceeds a preset value, and output a rapid close command to the regulator valves of the steam turbine if the power unload balance is detected.

The general thermal power plant does not include an intermediate-pressure drum 14, which is a primary factor of change in reheat steam temperature, or a cooling steam unit to cool a high-temperature portion of the gas turbine as described above in the second embodiment. Therefore, the degree of change in high-temperature reheat steam temperature is low. However, even if the high-temperature reheat steam temperature increases or decreases, the value of the steam turbine output can be calculated more accurately as compared to the conventional art by applying, for example, the above-described method of exponentiating the value of a pressure detecting signal of a steam pressure measured downstream from the reheater. Thus, if far load rejection occurs, the power load unbalance can be detected with high accuracy.

As detailed above, according to the embodiments, it is possible to provide a power plant and a method for operating the power plant, in which power load unbalance can be detected more accurately.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A combined cycle power plant comprising:
a steam turbine including a high-pressure turbine, an intermediate-pressure turbine and a low-pressure turbine;
a gas turbine disposed coaxially with the steam turbine;
a power generator disposed coaxially with the steam turbine and the gas turbine; and
an exhaust heat recovery boiler, which recovers exhaust gas from the gas turbine, generates steam and includes a high-pressure drum, an intermediate-pressure drum, a low-pressure drum and a reheater,
the combined cycle power plant being configured to introduce steam generated in the high-pressure drum into the high-pressure turbine through a high-pressure main steam regulator valve and drive the high-pressure turbine, join exhaust steam of the high-pressure turbine with steam generated in the intermediate pressure drum, supply and reheat the joined exhaust steam in the reheater, guide the steam reheated by the reheater to the intermediate-pressure turbine through a reheat steam regulator valve to drive the intermediate-pressure turbine, and guide steam generated in the low-pressure drum and passed through a low-pressure steam regulator valve together with steam that has been guided to and worked in the intermediate-pressure turbine to the low-pressure turbine and drive the low-pressure turbine,
the combined cycle power plant further comprising:
a gas turbine output calculating unit configured to calculate a gas turbine output;
a steam turbine output calculating unit configured to calculate a steam turbine output;
a turbine output calculating unit configured to add the gas turbine output and the steam turbine output together and calculate a turbine output;
a power generator output calculating unit configured to calculate a power generator output generated by the power generator;
an output deviation detecting unit configured to detect a deviation between the turbine output and the power generator output;
a power load unbalance detecting unit configured to detect power load unbalance when the deviation detected by the output deviation detecting unit exceeds a preset value; and
a control unit configured to output a rapid close command to regulator valves of the steam turbine based on a power load unbalance signal output from the power load unbalance detecting unit,
the steam turbine output calculating unit being configured to calculate the steam turbine output based on an exponential value of a steam pressure measured at an arbitrary point downstream from the reheater.

2. The combined cycle power plant according to claim 1, further comprising a low-temperature reheat steam system through which the exhaust steam of the high-pressure turbine flows and a cooling steam system branched off from the low-temperature reheat steam system to cool a high-temperature portion of the gas turbine.

3. A combined cycle power plant comprising:
a steam turbine comprising a high-pressure turbine, an intermediate-pressure turbine and a low-pressure turbine;
a first power generator disposed coaxially with the steam turbine;
a plurality of units, each unit including at least a gas turbine disposed on an axis different from the steam turbine, a second power generator disposed coaxially with the gas turbine, and an exhaust heat recovery boiler, which recovers exhaust gas from the gas turbine, generates steam and includes a high-pressure drum, an intermediate-pressure drum, a low-pressure drum and a reheater,
the combined cycle power plant being configured to join steam generated in the high-pressure drums of the plurality of units, introduce the joined steam into the high-pressure turbine through a high-pressure main steam regulator valve and drive the high-pressure turbine, join exhaust steam of the high-pressure turbine with steam generated in the intermediate pressure drums, supply and reheat the joined exhaust steam in the reheaters, join the steam reheated by the reheaters of the plurality of units, guide the joined steam to the intermediate-pressure turbine through a reheat steam regulator valve to drive the intermediate-pressure turbine, join the steam generated in the low-pressure drums of the plurality of units, and guide steam passed through a low-pressure steam regulator valve together with steam that has been guided to and worked in the intermediate-pressure turbine to the low-pressure turbine and drive the low-pressure turbine,
the combined cycle power plant further comprising:
a steam turbine output calculating unit configured to calculate a steam turbine output;
a power generator output calculating unit configured to calculate a power generator output generated by the second power generator;
an output deviation detecting unit configured to detect a deviation between the steam turbine output and the power generator output;
a power load unbalance detecting unit configured to detect power load unbalance when the deviation detected by the output deviation detecting unit exceeds a preset value; and
a control unit configured to output a rapid close command to regulator valves of the steam turbine based on a power load unbalance signal output from the power load unbalance detecting unit,
the steam turbine output calculating unit being configured to calculate the steam turbine output based on an exponential value of a steam pressure measured at an arbitrary point downstream from a point where steam exhausted from the reheaters of the plurality of units joins together.

4. The combined cycle power plant according to claim 1, wherein a value obtained by exponentiating a value of the measured steam pressure by a predetermined value is proportional to the steam turbine output.

5. The combined cycle power plant according to claim 1, further comprising an exponentiation calculation unit configured to exponentiate the value of the measured steam pressure by a predetermined value,
wherein the steam turbine output calculating unit is configured to calculate the steam turbine output by multiplying the exponential value of the steam pressure calculated by the exponentiation calculation unit by a predetermined value.

6. A power plant operating method applied to a power plant equipped with a steam turbine including a high-pressure turbine, an intermediate-pressure turbine and a low-pressure turbine; a power generator disposed coaxially with the steam turbine; and a boiler comprising a superheater which generates main steam for the high-pressure turbine and a reheater which heats at least steam exhausted from the high-pressure turbine, the power plant being configured to introduce main steam from the superheater into the high-pressure turbine through a high-pressure main steam regulator valve to drive the high-pressure turbine, supply and reheat at least steam exhausted from the high-pressure turbine in the reheater, guide at least steam reheated by the reheater into the intermediate-pressure turbine through a reheat steam regulator valve to drive the intermediate-pressure turbine, guide at least steam exhausted from the intermediate-pressure turbine into the low-pressure turbine to drive the low-pressure turbine, the method comprising:
calculating by a turbine output calculating unit a turbine output based on an exponential value of a steam pressure measured at an arbitrary point downstream from the reheater;
calculating by a power generator output calculating unit a power generator output generated by the power generator;
detecting by an output deviation detecting unit a deviation between the turbine output and the power generator output;
detecting by a power load unbalance detecting unit power load unbalance when the deviation exceeds a preset value; and
outputting by a control unit a rapid close command to regulator valves of the steam turbine when the power load unbalance is detected.

7. The combined cycle power plant according claim 3, wherein a value obtained by exponentiating a value of the measured steam pressure by a predetermined value is proportional to the steam turbine output.

8. The combined cycle power plant according claim 3, further comprising an exponentiation calculation unit configured to exponentiate the value of the measured steam pressure by a predetermined value,
wherein the steam turbine output calculating unit is configured to calculate the steam turbine output by multiplying the exponential value of the steam pressure calculated by the exponentiation calculation unit by a predetermined value.

9. The combined cycle power plant according claim 2, wherein a value obtained by exponentiating a value of the measured steam pressure by a predetermined value is proportional to the steam turbine output.

10. The combined cycle power plant according claim 2, further comprising an exponentiation calculation unit configured to exponentiate the value of the measured steam pressure by a predetermined value,
wherein the steam turbine output calculating unit is configured to calculate the steam turbine output by multiplying the exponential value of the steam pressure calculated by the exponentiation calculation unit by a predetermined value.
